(19) United States
(12) Patent Application Publication
(10) Pub. No.: US 2004/0003296 A1
(43) Pub. Date: Jan. 1, 2004

(54) Arrangement for reducing power in a networking device configured for operating at selected network speeds

(76) Inventors: Stephen Mc Robert, Sunnyvale, CA (US); Jeffrey Dwork, San Jose, CA (US); Robert Alan Williams, Cupertino, CA (US)

Correspondence Address: MANELLI DENISON & SELTER, 2000 M STREET NW SUITE 700, WASHINGTON, DC, 20036-3307, US

(21) Appl. No.: 09/834,647

(22) Filed: Apr. 16, 2001

(51) Int. Cl. G06F 1/26

(52) U.S. Cl. 713/300

(57) ABSTRACT

A controller is configured for controlling a physical layer transceiver by setting the physical layer transceiver into a low-power operation. The physical layer transceiver is configured for operating at a selected data rate, from one of a high-speed data rate and a low data rate, according to an autonegotiation routine. The controller is configured for resetting the selected data rate to the low data rate in response to a low-power request, and restarting the autonegotiation for the low data rate within the physical layer transceiver. The controller responds to the low-power request based on a determined result of the autonegotiation for the low data rate. Hence, the controller overrides the physical layer transceiver, having selected the high-speed data rate based on autonegotiation, to renegotiate for the low data rate, enabling low-power operation at the low data rate with minimal complexity and no modification to the physical layer transceiver.

### BACKGROUND OF THE INVENTION

1. Field of the Invention

The present invention relates to power saving in networking devices such as IEEE 802.3 network interface devices.

2. Background Art

Local area networks use a network cable or other media to link stations on the network. Each local area network architecture uses a media access control (MAC) enabling network interface devices at each network node to access the network medium via a physical layer transceiver (PHY).

Physical layer (PHY) devices are configured for translating digital packet data received from a MAC across a standardized interface, e.g., a media independent interface (MII) according to IEEE 802.3 protocol, into an analog signal for transmission on the network medium, and for reception of analog signal transmitted from a remote node via the network medium. An exemplary physical layer transceiver is the commercially available Am79C874 NetPHY™-1LP Low Power 10/100-TX/FX Ethernet Transceiver from Advanced Micro Devices, Inc., Sunnyvale Calif. The Am79C874 NetPHY™-1LP provides autonegotiation capabilities enabling the automatic selection of data rate (e.g., 10 Mbps or 100 Mbps) and full or half duplex operation, based on the determined capabilities of a link partner.

Low power consumption is of increasing concern to consumers and manufacturers. In particular, workstation computers are currently being designed to include power saving mechanisms, where the workstation computer will shut itself down after a prescribed interval of inactivity. The workstation computer is designed to have multiple power supply domains, where a network interface within the workstation will remain in an operative state even though the host computer powers down into a standby state, enabling the network interface to maintain a wake-up routine for the workstation computer. An exemplary arrangement for enabling remote power up of a computer is disclosed in commonly assigned U.S. Pat. No. 5,938,771 to Williams et al.

A problem encountered with existing physical layer implementations is that operation at 100 Mbps cannot be performed using a low-power mode, since the physical layer transceiver at each end of the link needs to continually transmit scrambled idle symbols. Hence, the necessity for continually transmitted idle symbols in a 100 Mbps link prevents the reduction of power in the physical layer transceiver.

### SUMMARY OF THE INVENTION

There is a need for an arrangement that enables a network interface device having multiple selectable data rates to reduce power consumption during prescribed low-power intervals within the host computer.

There also is a need for arrangement that enables a network interface device to receive data packets according to a low-power consumption during a prescribed low-power interval.

These and other needs are attained by the present invention, where a controller is configured for controlling a physical layer transceiver by setting the physical layer transceiver for low-power operation. The physical layer transceiver is configured for operating at a selected data rate, from one of a high-speed data rate and a low data rate, according to an autonegotiation routine. The controller is configured for resetting the selected data rate to the low data rate in response to a low-power request, and restarting the autonegotiation for the low data rate within the physical layer transceiver. The controller responds to the low-power request based on a determined result of the autonegotiation for the low data rate. Hence, the controller overrides the physical layer transceiver, having selected the high-speed data rate based on autonegotiation, to renegotiate for the low data rate, enabling low-power operation at the low data rate with minimal complexity and no modification to the physical layer transceiver.

One aspect of the present invention provides a method comprising the steps of receiving a request requiring operating a physical layer transceiver according to a low-power operation. The physical layer transceiver is configured for operating at a selected data rate, from one of a high-speed data rate and a low data rate, according to an autonegotiation routine. The method also includes resetting the selected data rate to the low data rate and restarting the autonegotiation for the low data rate in response to the request, and responding to the request based on a determined result of the autonegotiation for the low data rate.

Another aspect of the present invention provides a network interface system including a physical layer transceiver configured for operating at a selected data rate, from one of a high-speed data rate and a low data rate, according to an autonegotiation routine, and a controller configured for controlling the physical layer transceiver. The controller is configured for resetting the selected data rate to the low data rate and restarting the autonegotiation for the low data rate, in response to a request requiring operating the physical layer transceiver according to a low-power operation. The controller also is configured for responding to the request based on a determined result of the autonegotiation for the low data rate.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed in the appended claims.

### BRIEF DESCRIPTION OF THE DRAWINGS

Reference is made to the attached drawings, wherein elements having the same reference numeral designations represent like elements throughout and wherein:

FIG. 1 is a diagram illustrating a network workstation system configured for controlling a physical layer transceiver into a low-power operation according to an embodiment of the present invention.

FIG. 2 is a diagram illustrating the method of controlling the physical layer transceiver of FIG. 1 into the low-power operation according to an embodiment of the present invention.

### BEST MODE FOR CARRYING OUT THE INVENTION

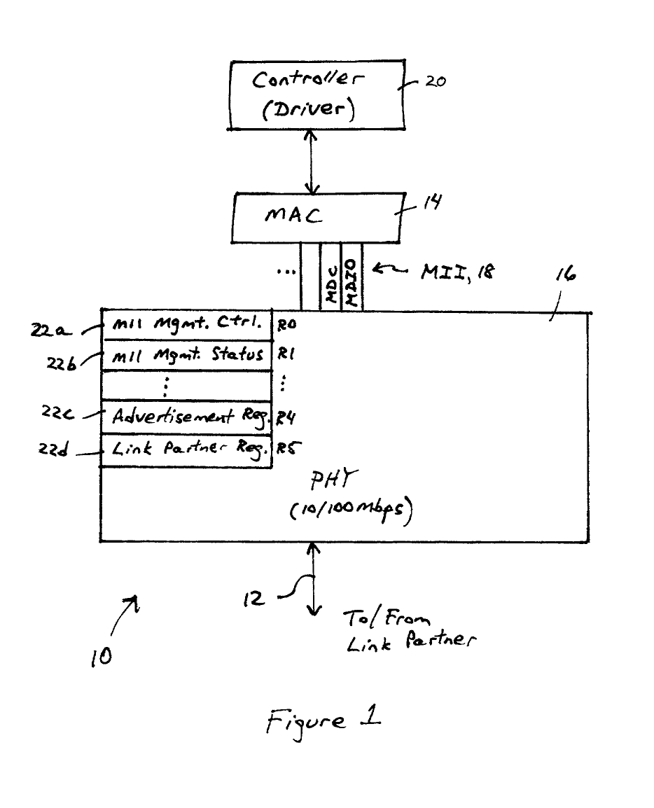

FIG. 1 illustrating a workstation system 10 configured for sending and receiving data packets across a network medium 12 according to IEEE 802.3 protocol. The workstation system 10 includes a media access controller (MAC) 14 configured for sending and receiving data packets according to IEEE 802.3 full duplex or half duplex protocol, and a physical layer transceiver 16 configured for translating digital packet data received from the MAC 14 across an MII 18 into analog signals for transmission on the network medium 12 according to a selected protocol. An exemplary physical layer transceiver 16 is the above-described Am79C874 NetPHY™-1LP Low Power 10/100-TX/FX Ethernet Transceiver from Advanced Micro Devices, Inc., Sunnyvale Calif. Alternatively, the physical layer transceiver 16 may be implemented on an integrated circuit that includes both the MAC 14 and the physical layer transceiver 16.

The workstation system 10 also includes a controller 20, implemented for example as an executable software driver resource that is executed by a microprocessor, and configured for controlling the MAC 14 and the physical layer transceiver 16 based on commands received from the operating system of the workstation 10. In particular, the controller 20 is configured for transmission and reception of data via the MAC 14 and the PHY 16, and management operations.

The PHY 16 typically is configured for performing autonegotiation with a link partner, where the PHY 16 and the corresponding link partner determine the highest data rate for transmission; for example, during autonegotiation the PHY 16 may be configured to select, in order of descending priority, 100Base-TX, full duplex, 100Base-TX, half duplex, 10BaseT, full duplex, or 10BaseT, half duplex. As described above, however, use of a 100 Mbps link requires the PHY 16 to continually transmit idle signals, limiting the ability to minimize power.

According to the disclosed embodiment, the controller 20 is configured for setting the PHY 16 into a low-power mode that minimizes power consumption while the workstation system 10 enters a low-power mode, for example where the workstation computer will shut itself down after a prescribed interval of activity while enabling the MAC 14 to initiate a wake-up routine in response to a remote command received from the network medium 12. In particular, the controller 20 resets the selected data rate in the PHY 16 to the low data rate (e.g., 10BaseT at half duplex), and restarts the autonegotiation process in the PHY 16 for the lower data rate. The use of a lower data rate such as 10BaseT at half duplex consumes substantially less power than use of the 100 Mbps link speed, since the use of 10BaseT at half duplex requires only that the PHY 16 outputs link pulses every few milliseconds, as opposed to sending idle symbols at a 100 Mbps data rate.

The controller 20 controls the PHY 16 based on accessing registers 22 within the PHY 16 via a management data input/output serial data path (MDIO) in the MII 18. In particular, the MII Management Control Register (R0) 22a and the MII Management Status Register (R1) 22b are configured for storing control information and status information, respectively, described in further detail below. The Autonegotiation Advertisement Register (R4) 22c and the Autonegotiation Link Partner Ability Register (R5) 22d are configured for storing transmission capabilities information for the PHY 16 and the link partner, respectively, enabling autonegotiation by the PHY 16 according to Clause 28 of the IEEE 802.3u specification.

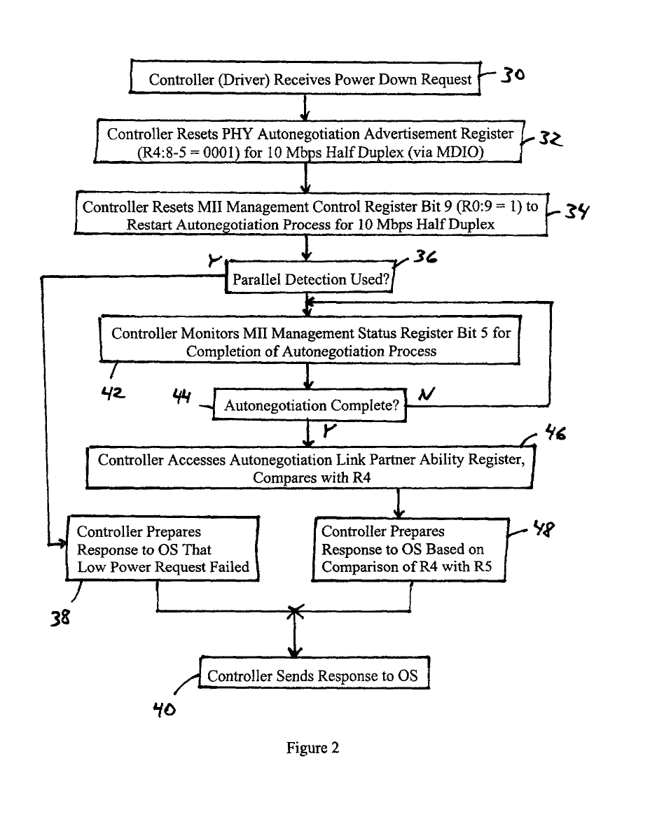

FIG. 2 is a diagram illustrating the method by the controller 20 of controlling the PHY 16 for low-power mode according to an embodiment of the present invention. The steps illustrated in FIG. 2 may be implemented as executable code stored on a tangible medium (e.g., hard disk, floppy disk, read-only memory, random access memory, compact disc, etc.), or alternately as programmable logic (e.g., programmable logic array).

The method begins in step 30, where the controller 20 receives a powerdown request from the operating system of the workstation system 10. The controller checks in step 31 if parallel detection is used. If in step 31 of the controller 20 determines that the PHY 16 and the link partner negotiate using parallel detection, for example if the link partner is a legacy 100Base-TX system incapable of negotiating down to 10 Mbps, the controller 20 prepares in step 38 a response indicating that the low-power request failed, and outputs the response to the operating system in step 40.

If in step 31 no parallel detection is used, the controller 20 resets the Autonegotiation Advertisement Register (R4) 22c in step 32 via the management data input/output (MDIO) path for negotiating a lower data rate, for example 10BaseT at half duplex. For example, the controller 20 would set bits 8-5 of R4 to 0001 binary, causing the PHY 16 to advertise its best capabilities as 10 Mbps half duplex. The controller 20 then restarts the autonegotiation process in step 34 by resetting bit 9 of the MII management control Register (R0) 22a to “1”.

The controller 20 monitors in step 42 bit 5 of the MII Management Status Register (R1) 22b to determine in step 44 when autonegotiation is complete. As recognized in the art, autonegotiation logic circuitry within the PHY 16 compares the advertised capabilities in the register 22c with the determined link partner abilities identified in the register 22d to identify a best match, which should be 10 Mbps half duplex based on step 32.

Once autonegotiation is complete, the controller 20 accesses in step 46 the Autonegotiation Link Partner Ability Register (R5) 22d and compares with the Autonegotiation Advertisement Register (R4) 22d to verify that the low-power 10 Mbps has been selected. The controller 20 prepares in step 48 a response to the operating system based on the comparison of the registers in step 46. The controller 20 sends in step 40 a response to the operating system identifying whether reconfiguring of the PHY 16 for low-power operation was successful.

The disclosed embodiment enables a workstation to utilize a high-speed data rate for optimum bandwidth during active use, while minimizing power consumption by utilizing a low-power data rate such as 10BaseT during periods of inactivity. The disclosed embodiment also is applicable to gigabit Ethernet, where a physical layer transceiver configured for selecting between a gigabit data rate, a 100 Mbps data rate, or a 10 Mbps data rate, may be reset from the gigabit data rate to a 10 Mbps data rate for low-power operations.

While this invention has been described with what is presently considered to be the most practical preferred embodiment, it is to be understood that the invention is not limited to the disclosed embodiments, but, on the contrary, is intended to cover various modifications and equivalent arrangements included within the spirit and scope of the appended claims.

What is claimed is:

1. A method comprising:
receiving a request requiring operating a physical layer transceiver according to a low-power operation, the physical layer transceiver configured for operating at a selected data rate, from one of a high-speed data rate and a low data rate, according to an autonegotiation routine;
resetting the selected data rate to the low data rate and restarting the autonegotiation for the low data rate in response to the request; and
responding to the request based on a determined result of the autonegotiation for the low data rate.

2. The method of claim 1, wherein the resetting and restarting step includes:
first writing a first value specifying the low data rate into a first prescribed register within the physical layer transceiver; and
second writing a second value specifying restarting the autonegotiation process into a second prescribed register within the physical layer transceiver.

3. The method of claim 2, wherein the first prescribed register is an autonegotiation advertisement register for the physical layer transceiver.

4. The method of claim 3. wherein the responding step includes:
accessing an autonegotiation link partner ability register, configured for storing configuration information for a link partner in communication with the physical layer transceiver, upon completion of the autonegotiation for the low data rate; and
responding to the request based on determining whether the autonegotiation link partner ability register indicates the low data rate was selected.

5. The method of claim 2, wherein the second prescribed register is a media independent interface (MII) management control register.

6. The method of claim 2, wherein the resetting and restarting step further includes accessing the first prescribed register and the second prescribed register via a serial management data input/output path of a media independent interface.

7. The method of claim 1, wherein the receiving step includes receiving the request by an executable driver resource configured for controlling the physical layer transceiver, the executable driver resource performing the resetting and restarting step and the responding step based on receiving the request, the executable driver resource configured for identifying whether the physical layer transceiver communicates with a link partner according to one of autonegotiation for the low data rate and parallel detection, the controller identifying failure of the request based on detecting use of the parallel detection.

8. The method of claim 1, wherein the low data rate corresponds to a 10 Mbps data rate according to IEEE 802.3 half duplex protocol.

9. A network interface system including:
a physical layer transceiver configured for operating at a selected data rate, from one of a high-speed data rate and a low data rate, according to an autonegotiation routine; and
a controller configured for controlling the physical layer transceiver, the controller configured for resetting the selected data rate to the low data rate and restarting the autonegotiation for the low data rate, in response to a request requiring operating the physical layer transceiver according to a low-power operation, the controller configured for responding to the request based on a determined result of the autonegotiation for the low data rate.

10. The system of claim 9, wherein the physical layer transceiver includes a first prescribed register configured for storing autonegotiation advertisement information for the physical layer transceiver, the controller configured for resetting the selected data rate by writing a first value specifying the low data rate into the first prescribed register.

11. The system of claim 10, wherein the physical layer transceiver includes a second prescribed register configured for storing management control information, the controller configured for restarting the autonegotiation for the low data rate by setting a prescribed bit within the second prescribed register.

12. The system of claim 11, wherein the physical layer transceiver includes a third prescribed register configured for storing autonegotiation link partner ability information for a link partner in communication with the physical layer transceiver, the controller configured for accessing the third prescribed register upon completion of the autonegotiation for the low data rate, to determine whether the low data rate was selected.

13. The system of claim 12, wherein the physical layer transceiver includes a media independent interface having a management data input/output serial path, the controller configured for accessing the first prescribed register, the second prescribed register, and the third prescribed register via the management data input/output serial path.

14. The system of claim 9, wherein the low data rate corresponds to a 10 Mbps data rate according to IEEE 802.3 half duplex protocol.

15. The system of claim 9, wherein the controller is configured for identifying whether the physical layer transceiver communicates with a link partner according to one of autonegotiation for the low data rate and parallel detection, the controller identifying failure of the request based on detecting use of the parallel detection.
